(19) United States
(12) Patent Application Publication
(10) Pub. No.: US 2026/0204987 A1
(43) Pub. Date: Jul. 16, 2026

(54) POSITION DETECTOR FOR A SPATIAL GEARED STEPPING MOTOR

(71) Applicant: SAFRAN ELECTRICAL & POWER, BLAGNAC (FR)

(72) Inventors: Emmanuel ESTEBAN, MOISSY-CRAMAYEL (FR); Jens ANDERS, MOISSY-CRAMAYEL (FR); Thomas MARTIN, MOISSY-CRAMAYEL (FR); Thomas JANNOT, MOISSY-CRAMAYEL (FR)

(21) Appl. No.: 19/134,734

(22) PCT Filed: Dec. 19, 2023
(86) PCT No.: PCT/EP2023/086661

§ 371 Date: Jun. 1, 2025

(30) Foreign Application Priority Data
Dec. 20, 2022 (FR) FR2213981

(51) Int. Cl. H02K 11/215; G01D 5/252

(52) U.S. Cl. CPC H02K 11/215; G01D 5/2525

(57) ABSTRACT

A rotary device includes a fixed part and a rotary part rotatable about an axis of rotation with respect to the fixed part, the rotary device including an angular-position detector detecting the angular position of the rotary part with respect to the fixed part, the angular-position detector including: a magnet secured to the rotary part and able to generate magnetic flux along a radial axis of the rotary part, a binary magnetic-field detector secured to the fixed part and configured to switch from a state referred to as open to a state referred to as closed when the binary magnetic-field detector has the magnetic flux of the magnet passing through it.

### CROSS-REFERENCE TO RELATED APPLICATIONS

This application is a National Stage of International patent application PCT/EP2023/086661, filed on Dec. 19, 2023, which claims priority to foreign French patent application No. FR 2213981, filed on Dec. 20, 2022, the disclosures of which are incorporated by reference in their entireties.

### FIELD OF THE INVENTION

The invention relates to the field of the detection of the angular position of a rotary device comprised in an antenna. More particularly, the invention relates to the detection of angular position intended for the control of a permanent-magnet stepping motor. The invention finds a particularly advantageous application in the field of space activities and antennas, for which the detection of the position of the rotary element needs to be precise, but is also suitable for any system comprising a rotary component requiring the detection of its position with respect to a fixed component or of the number of complete rotations effected by said rotary component.

### BACKGROUND

Traditionally, in order to detect the angle of rotation of the rotary element, it is commonplace to use a wheel-type incremental optical encoder which returns data for the precise control of the speed and positioning of the rotary element. Nevertheless, that type of component has the disadvantage of requiring substantial processing electronics in order to return data regarding the position of the rotary element. Furthermore, the need, associated with space applications, to determine very precise angular positions again entails the use only of high-precision models of encoder for which the financial cost is high.

As an alternative to that, the use of a Hall-effect position sensor may be envisioned. However, that type of sensor has a failure rate higher than that of incremental encoders.

Furthermore, the use of an absolute encoder, for example a potentiometer, may also be envisioned. However, that type of encoder likewise requires processing electronics and even an analog-digital converter. In addition, that type of encoder is more frequently subject to failure through wear, notably vibrations, this being a fact to be taken into consideration in an environment in which the mechanical conditions are often harsh with strong vibrations and high temperatures.

Finally, the use of a capacitive sensor may be envisioned, yet once again, the temperature and humidity coefficients to which it will be subjected make this a somewhat unconvincing alternative.

In addition, all of the cited solutions are active in nature and therefore require conditioning electronics that increase the overall volume of the system and the risk of failure due to the on-board electronics.

### SUMMARY OF THE INVENTION

The invention seeks to overcome all or some of the above-mentioned problems by proposing an angular-position detector based on a simple magnetic structure able to trigger rebound-free switching of a collection of reed switches for indicating the position of the rotary element of a stepping motor operated by a control signal. The angular-position detector according to the invention offers the advantage of being made up of a minimum number of electronic components, these components being passive and suitable for systems intended for space activities.

To this end, the invention relates to a rotary device comprising a fixed part and a rotary part rotatable about an axis of rotation with respect to the fixed part, the rotary device comprising an angular-position detector detecting the angular position of the rotary part with respect to the fixed part, the angular-position detector comprising:
a magnet secured to the rotary part and able to generate magnetic flux along a radial axis of the rotary part,
a binary magnetic-field detector secured to the fixed part and configured to switch from a state referred to as open to a state referred to as closed when the binary magnetic-field detector has the magnetic flux of the magnet passing through it.

According to one aspect of the invention, the binary magnetic-field detector comprises a first reed switch, the first reed switch comprising two edges and being configured to switch from the state referred to as open, in which the two edges are distant from one another, to the state referred to as closed, in which the two edges are electrically connected, when the magnetic flux of the magnet is passing through the first reed switch.

According to one aspect of the invention, the binary magnetic-field detector comprises a second reed switch secured to the fixed part, the second reed switch comprising two edges of the second reed switch and being configured to switch from the state referred to as open to the closed state when the magnetic flux of the magnet is passing through the second reed switch, the second reed switch being distant from the first reed switch by a predefined angle with respect to the axis of rotation of the rotary part.

According to one aspect of the invention, the first reed switch and the second reed switch are connected electrically in series.

According to one aspect of the invention, the first reed switch and the second reed switch are distant from the axis of rotation by a predefined length.

According to one aspect of the invention, the first reed switch and the second reed switch are configured to have a common detection range, the common detection range representing the angular range over which the switching of the first reed switch and of the second reed switch from the open state to the closed state is taking effect.

According to one aspect of the invention, the first reed switch and the second reed switch are comprised in a second component obtained from a high-performance thermoplastic material.

According to one aspect of the invention, the rotary device comprises an adjusting device for adjusting the position of the first reed switch and of the second reed switch with respect to the fixed component.

According to one aspect of the invention, the magnet is comprised in a first component obtained from a high-performance thermoplastic material.

According to one aspect of the invention, the rotary device comprises at least one flux-channeling element configured to channel the magnetic flux of the magnet radially with respect to the axis of rotation of the rotary component.

According to one aspect of the invention, the rotary device comprises a magnetic protection shield configured to isolate the rotary part and the fixed part from flux originating from an environment external to the rotary device.

### BRIEF DESCRIPTION OF THE DRAWINGS

According to one aspect of the invention, the rotary device is a stepping motor.

The invention will be better understood and other advantages will become apparent from reading the detailed description of one embodiment given by way of example, the description being illustrated by the attached drawing in which:

FIG. 1 depicts an exploded view of a rotary device comprising an angular-position detector according to the invention;

FIG. 2 depicts a view in section of the rotary device of FIG. 1;

FIG. 3 depicts a schematic view in section of a variant of the rotary device of FIG. 1;

FIG. 4 depicts a schematic view in section of the rotary device comprising a bias magnet;

FIG. 5 depicts a graph of the state of activation of the reed switches leading to detection of the angular position of the rotary component.

For the sake of clarity, the same elements will bear the same reference signs in the various figures.

### DETAILED DESCRIPTION

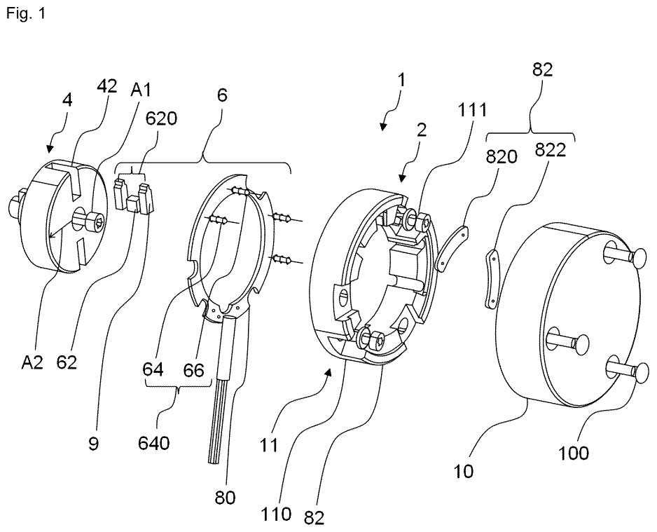

FIG. 1 depicts an exploded view of a rotary device 1 comprising a fixed part 2, commonly referred to as stator, and a rotary part, commonly referred to as rotor 4, rotatable about an axis of rotation A1 with respect to the fixed part 2.

The rotary device 1 also comprises an angular-position detector 6 detecting the angular position of the rotary part 4 with respect to the fixed part 2. The angular-position detector 6 comprises a magnet 62 secured to the rotary part 4 and able to generate magnetic flux along a radial axis A2 extending out from the axis of rotation A1 of the rotary part 4. The magnet 62 is considered to be the rotor 620 of the angular-position detector 6. This rotor 620 therefore experiences identical rotation to the rotary part 4. For this purpose, the rotary part 4 comprises a housing 42 in which the magnet 62 is inserted so that the magnetic poles of the magnet 62 are aligned with the radial axis A2. Thus, the magnet 62 generates magnetic flux extending along the radial axis A2 and also subjected to the rotation of the rotary part 4.

By way of indicative example, the magnet 62 is an Sm2Co17 magnet. This type of magnet offers the advantage of occupying a smaller amount of space compared with other types of magnet. An Sm2Co17 magnet also has high remanent flux density, of the order of 1.1 Tesla, and high specific energy, of the order of 240 kJ/m³. The coefficients governing the thermal variation in remanent flux density and coercive field strength of this Sm2Co17 magnet are also advantageous for the thermal cycles experienced by an orbiting satellite.

As a variant, any type of magnetic structure suitable for generating magnetic flux extending along the radial axis A2 may be envisioned. By way of indicative example, an electromagnet may be envisioned. A commutator system for supplying power to the electromagnet, or an inductive power-supplying system may be coupled to the electromagnet by on-board electronics. Nevertheless, the use of an electromagnet, of its power supply and of these on-board electronics requires a larger volume by comparison with the magnet 62.

The magnet 62 and the rotor 620 of the angular-position detector are therefore made to rotate at the pace of the rotary part 4 and generate a variation in the magnetic field along the radial axis A2.

The angular-position detector 6 comprises a binary magnetic-field detector secured to the fixed part 2 and configured to switch from a state referred to as open to a state referred to as closed when the binary magnetic-field detector has the magnetic flux of the magnet 62 passing through it. The binary magnetic-field detector is, by way of indicative example, a sensor that delivers an item of binary data as the magnetic field varies.

The angular-position detector 6 comprises for example a first reed switch 64 secured to the fixed part 2. The first reed switch 64 comprises two edges, or two contacts, and is configured to switch from a state referred to as open, in which the two edges are distant from one another, to a state referred to as closed, in which the two edges are electrically connected, when the magnetic flux of the magnet 62 is passing through the first reed switch, so as to generate a pulse or a change in state when the magnetic field strength exceeds a predefined value.

In effect, a reed switch is a magnetic switch comprising two contacts. These two contacts, or edges, which, by way of indicative example, are made from an iron-nickel alloy, can be magnetized and are elastic. Thus, in the presence of a magnetic field in excess of a predefined field strength, the contacts become magnetized by induction and are attracted one to the other. The contacts move closer together until they touch, a state that can be observed through their ability to pass current. When the magnetic field strength drops below the predefined value, the magnetization of the reeds is no longer sufficient to establish contact between the reeds, terminating the electrical connection.

According to one variant, the magnet 62 is inserted in the housing 42 in such a way as to generate the magnetic flux perpendicular to the radial axis A2. As a result, although the magnetic flux is not directed directly in the direction of the first reed switch 64, the first reed switch detects a variation in the magnetic field causing it to switch from the open state to the closed state and vice versa.

Normally, the two contacts are distant from one another by ten microns or so, but, under the effect of a strong magnetic field, they move closer together until the reed switch closes.

Now, for a defined position and a defined orientation of the first reed switch 64 and the fixed part 2 and for a defined path followed by the magnet 62, and particularly of the magnetic field generated by the magnet 62 in the vicinity of the first reed switch 64, it is then possible to determine a range of angular positions for the magnet 62, the rotor 62 and therefore the rotary part 4 in which the first reed switch 64 switches into the closed state, namely the detection angle for the rotary part 4 with respect to the fixed part 2.

Therefore, by detecting the binary signal which is activated/deactivated from the first reed switch 64, it becomes conceivable to detect the angular position of the rotor 620, and therefore of the rotary part to which the magnet 62 is fixed, when the magnet 62, and particularly the magnetic field generated by the magnet 62, passes past the reed switch.

According to one preferred configuration, the rotary device 1 comprises a second reed switch 66 secured to the fixed part 2. The second reed switch 66 also comprises two edges or contacts of the second reed switch and is likewise configured to switch from the state referred to as open to the closed state when the magnetic flux of the magnet 62 is passing through the second reed switch 66. The first reed switch 64 and the second reed switch 66 may thus be considered as being the stator 640 of the angular-position detector, unable to move relative to the rotor 620.

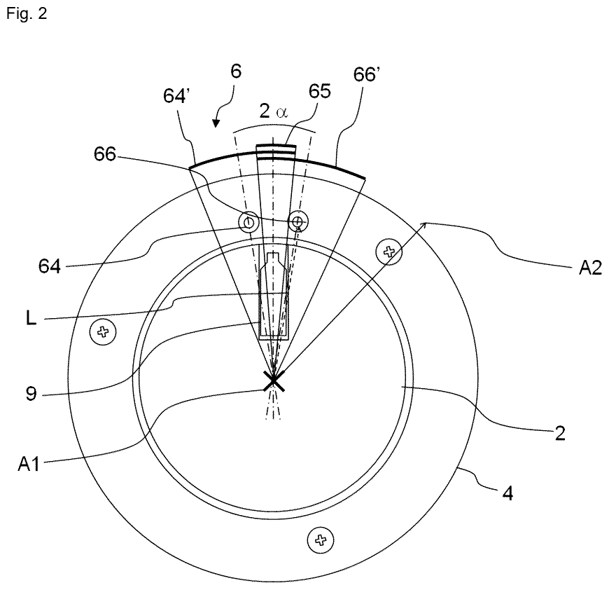

Furthermore, the second reed switch 66 is distant from the first reed switch 64 by a predefined angle 2∝ with respect to the axis of rotation A1 of the rotary part 4, as depicted in FIG. 2. In other words, the second reed switch 66 is angularly offset from the first reed switch 64 by a predefined angle 2∝ with respect to the axis of rotation A1 of the rotary part 4.

Specifically, because the magnet 62 operates at high temperatures, the magnetic field generated by the magnet 62 is thereby affected. As a result, it is necessary to bring the reed switch closer so that it can become magnetized and detect the passage of the magnetic field and therefore the angular position of the rotary part 4. In other words, it becomes necessary to vary the position of the magnet 62 and bring the reed switch closer to the magnet 62 along the radial axis A2. This enables the operation of the sensor, namely the reed switch, to be adjusted.

Nevertheless, this greater closeness presents disadvantages such as that of reducing the precision of the detection of the precise passage of the magnetic field past the reed switch or else that of temperature having an appreciable impact on the reed switch.

As a result, the angular positioning of the first and second reed switch 64 and 66 offers the advantage of increasing the precision of the detection of the angular position of the magnetic flux generated by the magnet 62 and therefore the angular position of the rotary part 4. Specifically, when the first reed switch 64 switches from the open state, in which the edges or contacts of the first switch 64 are parted, to the closed state, in which the edges are magnetized and in contact with one another so that electrical current can pass, while at the same time the second reed switch 66 remains in the open state, the magnetic field generated by the magnet 62 affects only the first reed switch 64, and the magnet 62, characterizing for example the angular position of the rotary component 4, is ahead of the first reed switch 64 considered in the direction of rotation of the rotary component 4. Conversely, when the second reed switch 66 switches from the open state, in which the edges or contacts of the second switch 66 are parted, to the closed state, in which the edges are magnetized and in contact with one another so that electrical current can pass, while at the same time the first reed switch 64 remains in the open state, the magnetic field generated by the magnet 62 affects only the second reed switch 66 and the magnet 62, characterizing for example the angular position of the rotary component 4, is beyond the second reed switch 66 considered in the direction of rotation of the rotary component 4.

As a result, when simultaneously both the first reed switch 64 switches from the open state to the closed state and the second reed switch 66 switches from the open state to the closed state, both the first and second reed switches 64 and 66 experience the effects of the magnetic field generated by the magnet 62. Thus it is possible to detect that the angular position of the magnet 62 and of the rotary component 4 is between the two angular positions of the first reed switch 64 and of the second reed switch 66.

In effect, each reed switch has its own detection angle or its own detection range. The first reed switch 64 therefore has a first detection range 64′ linked to the known angular position of the first reed switch 64, and the second reed switch 66 likewise has a second detection range 66′ linked to the known angular position of the second reed switch 66. These detection ranges represented by the first detection angle 64′ and the second detection angle 66′, by overlapping, give a common detection angle 65 or common detection angular range 65 which thus represents the angular position of the rotor 620 and therefore of the rotary part 4.

Another significant disadvantage connected with the variation in temperature is that the common detection angle 65 varies greatly with respect to the two detection ranges specific to the reed switches, namely the first detection range 64′ of the first reed switch 64 and the second detection range 66′ of the second reed switch 66.

For example, a 10% increase or decrease in the two detection ranges specific to the first and second reed switches 64 and 66 leads to a 40% increase or decrease in the common detection angular range 65.

Therefore, variations of the order of just a few percent in the magnetic behaviors of the first and second reed switches 64 and 66 and of the magnet 62 need to be taken into consideration. It is therefore necessary to adjust the position of the magnet 62 so that the variations affecting the common detection angular range 65 do not bring about one of the following two fault scenarios:
In a first scenario, when the common detection angular range 65 is too wide, which is to say when the common detection angle 65 is large, detection may occur also on the two steps adjacent to the step targeted by the stator 640 during damped oscillation of the rotor 620 as the rotor is positioning itself on one of these two adjacent steps. As a result, angular detection is imprecise.
In a second scenario, when the common detection angular range 65 is too narrow, which is to say when the common detection angle 65 is small, the loss of detection during damped oscillation of the rotor 620 as it is positioning itself on the targeted step may occur more frequently even though the rotor 620 is positioned on the targeted step.

In the scenario whereby the distance between the magnet 62 and the first and second reed switches 64 and 66 is small, the impact is not so strong because the ratio between the common detection angular range 65 and the detection angle of a single reed switch can be higher, reducing the uncertainty associated with the detection.

The term “simultaneously” is considered as meaning the state during which the first reed switch 64 and the second reed switch 66 are switched from the open state to the closed state, which is to say in the common detection angular range 65 as described above. Nevertheless, it is possible to envision also taking into consideration the moment ahead of the moment at which this simultaneous switching of the first and second reed switches 64 and 66 occurs, during which moment only the first reed switch 64 is switching from the open state to the closed state. Similarly, it is possible to envision taking into consideration the moment after the moment at which this simultaneous switching of the first and second reed switches 64 and 66 occurs, during which moment only the second reed switch 66 is switching from the open state to the closed state. Specifically, given that the magnetic flux generated by the magnet 62 is aligned with the radial axis and experiences the rotation of the rotary component 4, since the first and second reed switches 64 and 66 are separated from one another by a non-zero angle, it is logical that one reed switch becomes magnetized before the other reed switch. Furthermore, there is a delay during which the current has not begun to flow in a reed switch even though the reed switch is being subjected to the magnetic flux that causes it to switch. This is the delay needed for the two edges or contacts of the reed switch to become magnetized, to deform, and to come into contact so as to allow electrical current to pass through the reed switch. As a result, it becomes important to take into consideration the moments ahead of and after the moment at which the switching of the first and second reed switches 64 and 66 occurs in order to obtain precise knowledge of the angular position of the rotary component 4, represented for example by the magnet 62.

By way of indicative example, it may then be estimated that the magnet 62 is situated at the center of the arc formed between the first reed switch 64 and the second reed switch 66, as depicted in FIG. 2. Now, because the first and second reed switches 64 and 66 are distant by an angle 2α, the angular position of the magnet 62 and of the rotary component 4 can easily be determined.

As a variant, a reference determining the angular position of the rotary component 4 may be envisioned and the angular distance between this reference and the magnet 62 along the radial axis A2 is known.

By way of indicative example, the predefined angle between the first reed switch 64 and the second reed switch 66 is an angle between 10° and 30°. As a preference, the predefined angle between the first reed switch 64 and the second reed switch 66 is an angle between 15° and 20°, and in an ideal configuration, the predefined angle is 18°.

In order to detect the moment during which the switching of the first reed switch 64 and of the second reed switch 66 is taking effect, which is to say the common detection angular range 65 depicted in FIG. 2, the first reed switch 64 and the second reed switch 66 are connected electrically in series. This electrical connection offers the advantage of isolating the overlap of the detection zones of each of the first and second reed switches 64 and 66 in order to obtain a smaller centered detection zone.

Stated differently, the first reed switch 64 and the second reed switch 66 are configured to have a common detection range 65 representing the angular range over which the switching of the first reed switch 64 and of the second reed switch 66 from the open state to the closed state is taking effect.

According to a preferred configuration of the invention, the rotary device 1 is a stepping motor. As a result, the rotation of the rotary part 4 is incremented by a defined angle, namely the step. The rotor 620, and more particularly the magnet 62, of the position detector 6 is indexed to a step of the rotary part 4 of the stepping motor. The first reed switch 64 and the second reed switch 66 are themselves positioned along the radial axis A2, one on each side of the step, so that the step is positioned between the first reed switch 64 and the second reed switch 66 on an arc connecting the first and second reed switches 64 and 66. This indexing of the position of the rotor 620 and of the stator 640, represented by the first reed switch 64 and the second reed switch 66, over one step of the stepping motor thus enables the magnetic field generated by the magnet 62 to be stopped between the first reed switch 64 and the second reed switch 66 when the stepping motor is in one of its stable positions.

Thus, having the first reed switch 64 and the second reed switch 66 mounted in series offers the advantage of highlighting that a signal in the high state, indicating that the first and second reed switches are in the closed state, means that the stepping motor has stopped on the targeted step, namely is positioned between the first reed switch 64 and the second reed switch 66.

According to one variant, a second pair of reed switches is positioned 120° from the first pair of reed switches which is formed by the first reed switch 64 and the second reed switch 66, facing another stable position of the stepping motor, in order to provide redundancy.

Any other angle between the first pair of reed switches and the second pair of reed switches may be considered, provided that the second pair of reed switches is facing another stable position of the stepping motor.

According to another configuration, the rotary device is a rotary motor.

As mentioned previously, the distance along the radial axis A2 between the magnet 62, or the axis of rotation A1, and the first and second reed switches 64 and 66 is an important factor. Specifically, too small a distance is detrimental to the precision of the detection of the angular position of the magnet 62 and of the rotary component 4, whereas too large a distance prevents any magnetizing of the reed switches. As a result, the first reed switch 64 and the second reed switch 66 are distant from the axis of rotation A1 by a predefined length L, depicted in FIG. 2. By way of indicative example, the predefined length L is a length of between 10 millimeters and 30 millimeters. According to one preferred configuration, the predefined length L between the axis of rotation A1 and the first and second reed switches 64 and 66 is a length of between 12 millimeters and 20 millimeters, and ideally is a length of 16 millimeters.

Furthermore, it should be noted that the presence of heat in the vicinity of a reed switch may be detrimental to the magnetizing of the edges or contacts. Now, there are three sources of heat that may be identified as having the potential to interfere with the rotary device 1 for space activity:
solar radiation passing through the rotary device,
heat losses from the stator 2 of the motor conducted via the rolling bearings and then the rotor 4,
transmitted and/or reflected radiation and conduction of heat from the structure of the satellite.

With a view to safeguarding against heat generated notably by solar radiation, the magnet 62 is contained in a first component 80 obtained from a high-performance thermoplastic material, as depicted in FIG. 1. The first component 80 is, by way of example, made of polyether ether ketone (PEEK). As a variant, any material with high resistance to heat is envisioned.

In addition, the first reed switch 64 and the second reed switch 66 are comprised in a second component 82 obtained from a high-performance thermoplastic material secured to the fixed part 2. The second component 82 is, by way of example, made of polyether ether ketone (PEEK). As an alternative, any material having properties such as good electrical insulation, with an outgassing rate adequate for a space environment and a high resistance to heat cycles is envisioned.

The second component 82 also offers the advantage of improving the relative positioning of the first reed switch 64 with respect to the second reed switch 66.

In order to afford the best possible protection to the first reed switch 64 and the second reed switch 66, the second component 82 made of thermoplastic material may be made up of two parts 820 and 822 which are positioned in such a way as to encapsulate each reed switch, as depicted in FIG. 1.

According to a preferred variant, the first component 80 and the second component 82 are printed circuit boards (PCBs). The first component 80 and the second component 82 also offer the advantage of enabling the first reed switch 64 and the second reed switch 66 to be held between the first component 80 and the second component 82 while at the same time having the first reed switch 64 and the second reed switch 66 in series. The use of the second component 82 offers the advantage that there is no need to curve the reed blades of the first reed switch 64 and of the second reed switch 66.

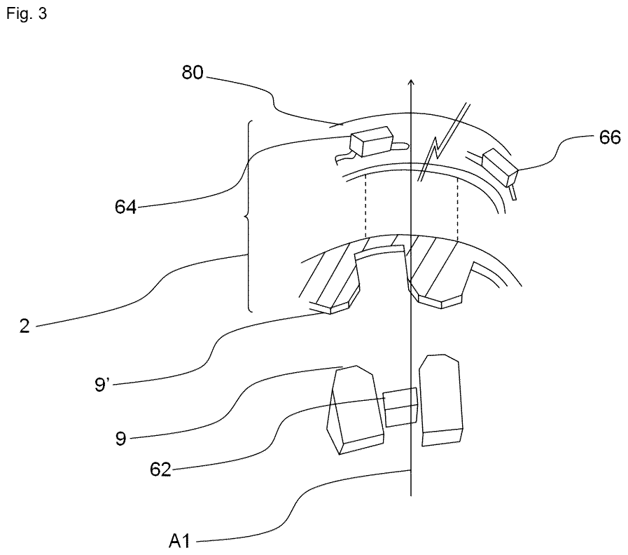

According to another configuration, the first reed switch 64 and the second reed switch 66 may be surface mount components (SMCs) mounted on the surface of the first component 80 as depicted in FIG. 3.

The use of the first reed switch 64 and of the second reed switch 66 as surface-mount components thus offers the advantage that they can be attached directly to the first component 80 without the need to use the second component 82, thus limiting the axial bulk along the axis of rotation A1.

It may also be envisioned to use two or a multitude of magnets 62 or magnetic poles on the rotary component 4. The magnets 62 are then arranged equidistantly.

This configuration based on the use of a plurality of magnets 62 distributed equidistantly in the rotary component 4 enables the generation of a multitude of pulses per revolution of the rotary component 4.

It may also be envisioned for the magnets 62 or the magnetic poles to be positioned directly at the level of a step or increment of the rotary part 4. This configuration then offers the advantage of being able to identify the step accomplished by the rotary part 4 in the scenario whereby a stepping motor is being used for example.

It may also be envisioned to use a plurality of pairs of reed switches identical to the first reed switch 64 and to the second reed switch 66 in order to obtain a redundant measurement of the angular position of the magnet 62. Specifically, the principal and redundant readings may be able to provide identical measurements by compensating for the angular offset in a predefined manner.

According to one variant, the rotary device 1 comprises at least one flux-channeling element 9 configured to channel the magnetic flux of the magnet 62 radially with respect to the axis of rotation A1 of the rotary component 4 so as to align the magnetic flux along the radial axis A2. As an alternative, the at least one flux-channeling element 9 is bonded to the magnet 62 using a polymerized adhesive that has good magnetic permeability. According to a preferred configuration, depicted in FIG. 1, the rotary device 1 comprises two flux-channeling elements 9 inserted in the housing 42 such that the magnet 62 is positioned between the two flux-channeling elements 9 along the axis of rotation A1. The rotor 620 therefore comprises the magnet 62 and the two flux-channeling elements 9.

The flux-channeling element 9 is, by way of indicative example, a pole piece for channeling the magnetic flux. The flux-channeling element 9 is, by way of indicative example, made of a ferromagnetic material.

According to one variant, the rotary device 1 comprises at least one flux-channeling element 9, positioned facing the first reed switch 64 against the fixed part 2 so as to channel the magnetic flux generated by the magnet 62 to the first reed switch 64. As a preference, the rotary device 1 comprises two flux-channeling elements 9 positioned near the first reed switch 64 against the fixed part 2 so that the first reed switch 64 lies between two flux-channeling elements 9.

Similarly, the rotary device 1 comprises at least one flux-channeling element 9, positioned near the second reed switch 66 against the fixed part 2 so as to channel the magnetic flux generated by the magnet 62 to the second reed switch 66. As a preference, the rotary device 1 comprises two flux-channeling elements 9 positioned near the second reed switch 66 against the fixed part 2 so that the second reed switch 66 lies between two flux-channeling elements 9. As a result, the stator 640 comprises the first and second reed switches 64 and 66 and the four flux-channeling elements 9.

The rotary device 1 may also comprise a magnetic protection shield 10 configured to isolate the rotary part 4 and the fixed part 2 from flux originating from an environment external to the rotary device 1. Thus, the magnetic protection shield 10 magnetically isolates the rotary device 1 from the external environment. As a result, the first reed switch 64 and the second reed switch 66 are less sensitive, or even not at all sensitive, to electromagnetic disturbances originating from other machines situated in the vicinity or originating from the external environment, such as cosmic radiation. The magnetic protection shield 10 is fixed to the stator 2 using paramagnetic screws 100. The use of paramagnetic screws 100 offers the advantage of absorbing a small portion of the magnetic flux in their vicinity and thus have a tendency to reduce the size of the common detection range 65.

As an alternative, it may be envisioned for the magnetic protection shield 10 to be fixed in place using screws.

According to another variant, the magnetic protection shield 10 is a paramagnetic shield.

The rotary device 1 may also comprise an adjusting device 11 for adjusting the position of the stator 640, and more particularly of the first reed switch 64 and of the second reed switch 66, with respect to the fixed component 2, so as to adjust the angular position of the stator 640 with respect to the rotor 620 and to the rotary component 4. The adjusting device 11 for adjusting the stator 640 causes the stator 640 to rotate with respect to the fixed component 2 about the axis of rotation A1 so as to shift the angular positions of the first reed switch 64 and of the second reed switch 66.

By way of indicative example, the adjusting device 11 for adjusting the position of the stator 640 with respect to the fixed component 2 comprises at least one channel 110 extending, along the fixed part 2, perpendicular to the axis of rotation A1 and radially with respect to the direction of rotation of the rotary part 4, and an adjusting screw 111 introduced into the channel 110 so as to immobilize the stator 640 with respect to the fixed part 2. This adjustment offers the advantage of allowing each pair of reed switches to be centered on a step of the stepping motor.

Furthermore, the position-adjusting device 11 is able to adjust the angular position of the fixed component 2 with respect to the component on which the fixed component is mounted, which in this instance is the rear end plate of the motor.

It may also be envisioned, as depicted in FIG. 3, for the fixed part 2 to comprise an inbuilt flux-channeling element 9′. This variant makes it possible to dispense with the use of a flux-channeling element 9 added in the vicinity of the magnet 62 or of the reed switches 64 or 66. The flux-channeling element 9′ thus takes the form of a planar protrusion 90′ perpendicular to the axis of rotation A1 projecting out from the fixed part 2. The flux-channeling element 9′ comprising this protrusion 90′ is thus able to redirect the magnetic flux toward the first and second reed switches 64 and 66.

It may also be envisioned for the flux-channeling element 9 positioned in the vicinity of the magnet 62 in the rotary part 4 to be combined with the flux-channeling element 9′ comprised in the fixed part 2 in order to optimize the redirection of magnetic flux from the poles of the magnet 62 to the first and second reed switches 64 and 66. In addition, in a preferred configuration, the flux-channeling element 9 positioned in the vicinity of the magnet 62 in the rotary part 4 and the flux-channeling element 9′comprised in the fixed part 2 form salient poles and teeth facing one another when the reluctance is minimal.

Furthermore, it may also be envisioned to work with a magnetic field that saturates the flux-channeling elements 9 and/or 9′ rather than capturing the magnetic field flux leakage. Operating with the flux-channeling elements 9 and 9′ saturated thus offers the advantage of obtaining detection that is less sensitive to external influences caused by temperature or manufacturing spread for example.

According to a preferred configuration, the flux-channeling elements 9 and 9′ are magnetic laminations.

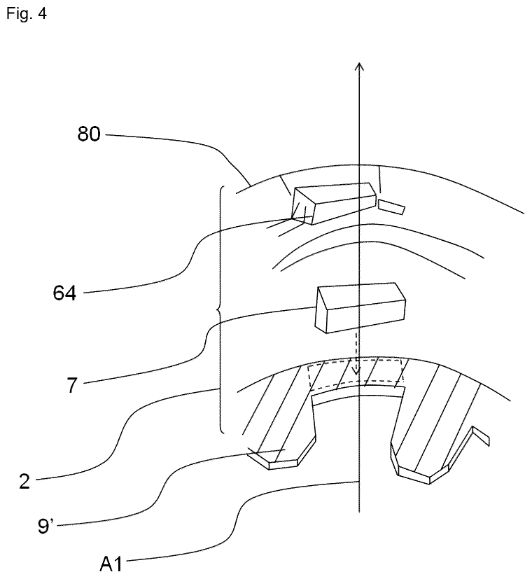

It may also be envisioned, as depicted in FIG. 4, to fit a bias magnet 7 lying in the field of detection of the first reed switch 64, namely the first detection range 64′, or in the field of detection of the second reed switch 66, namely the second detection range 66′. In other words, the bias magnet 7 is positioned near the first reed switch 64 and/or near the second reed switch 66. By way of indicative example, the bias magnet 7 is aligned with the first reed switch 64 along the axis of rotation A1. The fixed part 2 may also comprise a plurality of bias magnets 7 positioned near each reed switch 64 and 66. Specifically, the bias magnet 7 is able to generate a bias magnetic field that reduces the sensitivity of the first reed switch 64 and/or of the second reed switch 66. As a result, a detection made by the first reed switch 64 and by the second reed switch 66 requires a magnetic field that is stronger compared to the bias magnetic field generated by the bias magnet 7, thereby offering the advantage of reducing the risk of perturbation from external fields.

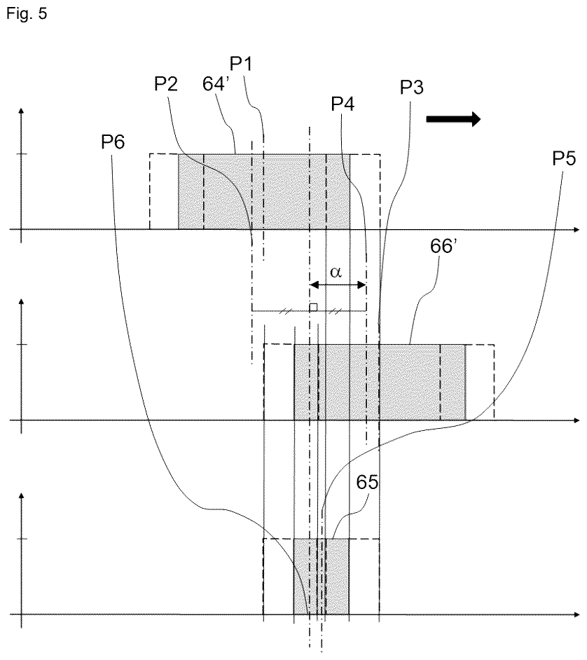

FIG. 5 depicts a graph of the respective states of activation of the first reed switch 64 and of the second reed switch 66, and a graph indicating the angular position of the rotary part 4 in the two states of activation of the first and second reed switches 64 and 66.

For each of the graphs, the abscissa axis represents the angular position of the rotary part 4 in the direction of rotation of the rotary part 4, and the ordinate axis represents the state of activation of the component.

Two states of activation are considered: a low state which corresponds to the open state of each reed switch, and a high state which corresponds to the closed state of each reed switch. As a result, when the magnetic field generated by the magnet 62 comes into contact with the first reed switch 64, the first reed switch 64 switches from the low or open state to the high or closed state, as depicted in FIG. 5.

Similarly, when the magnetic field generated by the magnet 62 comes into contact with the second reed switch 66, the second reed switch 66 switches from the low or open state to the high or closed state, with a delay with respect to the first reed switch 64, which delay is caused by the angular position being offset by the predefined angle 2∝ with respect to the angular position of the first reed switch 64.

Furthermore, as mentioned previously, there is a delay, known as the magnetic hysteresis, between the moment at which the first reed switch 64 is swept by the magnetic flux and the switching of the first reed switch 64 from the open state to the closed state. As a result, it is possible to discriminate between an electrical angular position P1 and a mechanical angular position P2. The electrical angular position P1 therefore represents the angular position of the rotary part 4 in which the first reed switch 64 is closed. By way of indicative example, the electrical angular position P1 may be considered as being the position that is centered with respect to the period for which the first reed switch 64 is in the high or closed state, as depicted in FIG. 5.

The mechanical angular position P2 therefore represents the angular position of the rotary part 4 for which the magnetic flux is having an influence on the first reed switch 64. Thus, by knowing the delay associated with the magnetic hysteresis, the mechanical angular position P2 of the rotary part 4 can be determined with respect to the electrical angular position P1. The mechanical angular position P2 is therefore ahead of the electrical angular position P1 in the direction of rotation of the rotary part 4.

Similarly, it is possible to detect an electrical angular position P3 of the rotary part 4 and a mechanical angular position P4 of the rotary part with respect to the second reed switch 66. The electrical angular position P3 therefore represents the angular position of the rotary part 4 in which the second reed switch 66 is closed. By way of indicative example, the electrical angular position P3 may be considered as being the position that is centered with respect to the period for which the second reed switch 66 is in the high or closed state.

The mechanical angular position P4 therefore represents the angular position of the rotary part 4 for which the magnetic flux is having an influence on the second reed switch 66. Thus, by knowing the delay associated with the magnetic hysteresis, the mechanical angular position P4 of the rotary part 4 can be determined with respect to the electrical angular position P3. The mechanical angular position P4 is therefore ahead of the electrical angular position P3 in the direction of rotation of the rotary part 4.

Furthermore, it is possible to verify the angular distance between the first reed switch 64 and the second reed switch 66 because the electrical angular position P1 then needs to be distant from the electrical angular position P3 by an angle 2α and the mechanical angular position P2 also needs to be distant from the mechanical angular position P4 by the angle 2α.

As a result, it is possible to detect the angular position of the rotary part 4 from the electrical angular position P1 measured by the first reed switch 64 and from the electrical angular position P3 measured by the second reed switch 66. By way of indicative example, the electrical angular position P5 of the rotary part 4 as detected from the electrical angular position P1 and from the electrical angular position P3 is a position that is centered between the electrical angular position P1 of the first reed switch 64 and the electrical angular position P3 of the second reed switch 66, equidistant between the electrical angular position P1 and the electrical angular position P3. This detection on the basis of the electrical angular position P1 and of the electrical angular position P3 may be deemed to be acceptable even though it is tainted by the imprecision caused by magnetic hysteresis.

As a variant, the mechanical angular position P6 of the rotary part 4 may be detected from the mechanical angular position P2 measured by the first reed switch 64 and from the mechanical angular position P4 measured by the second reed switch 66. By way of indicative example, the angular position of the rotary part 4 as detected from the mechanical angular position P2 and from the mechanical angular position P4 is a position that is centered between the mechanical angular position P2 of the first reed switch 64 and the mechanical angular position P4 of the second reed switch 66, equidistant between the mechanical angular position P2 and the mechanical angular position P4.

The angular-position detection device according to the invention offers the advantage of being able to emit a pulse or a square wave that indicates the position of the rotary part controlled by a command signal while remaining robust against mechanical disturbances during detection. The angular-position detection device according to the invention is also simple in design since it is made up of a minimum number of passive electronic components thus making it possible to minimize the need for costly advanced processing electronics, and is compatible with the quality requirements of current European standards concerned with systems intended for space activities.

The angular-position detector according to the invention is based on the use of a pair of reed switches connected in series. Series-connection makes it possible to isolate the overlap of the detection zones of each of the reed switches in order to obtain a smaller detection zone.

1. A rotary device comprising a fixed part and a rotary part rotatable about an axis of rotation (A1) with respect to the fixed part, the rotary device comprising an angular-position detector detecting the angular position of the rotary part with respect to the fixed part, the angular-position detector comprising:
a magnet secured to the rotary part and able to generate magnetic flux along a radial axis (A2) of the rotary part,
a binary magnetic-field detector secured to the fixed part and configured to switch from a state referred to as open to a state referred to as closed when the binary magnetic-field detector has the magnetic flux of the magnet passing through it, the binary magnetic-field detector comprising:
a first reed switch, the first reed switch comprising two edges and being configured to switch from the state referred to as open, in which the two edges are distant from one another, to the state referred to as closed, in which the two edges are electrically connected, when the magnetic flux of the magnet is passing through the first reed switch,
a second reed switch secured to the fixed part the second reed switch comprising two edges of the second reed switch and being configured to switch from the state referred to as open to the closed state when the magnetic flux of the magnet is passing through the second reed switch, the second reed switch being distant from the first reed switch by a predefined angle with respect to the axis of rotation (A1) of the rotary part, and
the first reed switch and the second reed switch being comprised in a second component obtained from a high-performance thermoplastic material with a low outgassing rate.

2. The rotary device as claimed in claim 1, wherein the first reed switch and the second reed switch are connected electrically in series.

3. The rotary device as claimed in claim 1, wherein the first reed switch and the second reed switch are distant from the axis of rotation (A1) by a predefined length.

4. The rotary device as claimed in claim 1, wherein the first reed switch and the second reed switch are configured to have a common detection range, the common detection range representing the angular range over which the switching of the first reed switch and of the second reed switch from the open state to the closed state is taking effect.

5. The rotary device as claimed in claim 1, comprising an adjusting device for adjusting the position of the first reed switch and of the second reed switch with respect to the fixed component.

6. The rotary device as claimed in claim 1, wherein the magnet is comprised in a first component obtained from a high-performance thermoplastic material.

7. The rotary device as claimed in claim 1, comprising at least one flux-channeling element configured to channel the magnetic flux of the magnet radially with respect to the axis of rotation (A1) of the rotary component.

8. The rotary device as claimed in claim 1, comprising a magnetic protection shield configured to isolate the rotary part and the fixed part from flux originating from an environment external to the rotary device.

9. The rotary device as claimed in claim 1, the rotary device being a stepping motor.
